(19) United States
(12) Patent Application Publication
(10) Pub. No.: US 2020/0184014 A1
(43) Pub. Date: Jun. 11, 2020

(54) INTERNET OF EVERYTHING

(71) Applicant: SAP SE, Walldorf (DE)

(72) Inventors: Dennis Ahaus, Hemsbach (DE); Otto Boehrer, Wiesloch (DE); Stephan Herbert, Viernheim (DE); Rainer Schmidtke, Philippsburg (DE)

(21) Appl. No.: 16/213,104

(22) Filed: Dec. 7, 2018

(51) Int. Cl. G06F 17/27

(52) U.S. Cl. CPC G06F 17/2785

(57) ABSTRACT

The disclosure generally describes methods, software, and systems for processing information received from Internet of Things (IoT) devices, including a computer-implemented method in which information is received in a semantic recognition system (SRS). The information includes a device identifier (ID) of a first device, a payload containing information transmitted by the first device, and semantic information associated with the first device. A semantic model for the first device is determined by the SRS using the device ID and the semantic information. A digital twin representing the first device is generated by the SRS.

### BACKGROUND

The present disclosure relates to processing information received from Internet of Things (IoT) devices. An IoT device can be, for example, a sensor, a car, a machine, or another piece of equipment. IoT devices may interact with one or more humans or may be fully autonomous. IoT devices can send and receive information over the Internet and other networks. Each piece of information that is received from an IoT device can have a specific meaning, such as a temperature reading on a sensor.

### SUMMARY

This disclosure generally describes computer-implemented methods, software, and systems for processing information received from Internet of Things (IoT) devices. One computer-implemented method includes: receiving, in a semantic recognition system (SRS), information including a device identifier (ID) of a first device, a payload containing information transmitted by the first device, and semantic information associated with the first device; determining, by the SRS, a semantic model for the first device using the device ID and the semantic information; and generating, by the SRS, a digital twin representing the first device.

The foregoing and other implementations can each optionally include one or more of the following features, alone or in combination. In particular, one implementation can include all the following features:

In a first aspect, combinable with any of the previous aspects, wherein the first device is a sensor.

In a second aspect, combinable with any of the previous aspects, wherein the received information is received from a sensor gateway that adds the semantic information.

In a third aspect, combinable with any of the previous aspects, wherein determining the semantic model includes identifying, using the device ID of the first device and the semantic information associated with the first device, an existing semantic model associated with the first device.

In a fourth aspect, combinable with any of the previous aspects, wherein determining the semantic model comprises: generating, by the SRS, a new semantic model for a device type associated with the first device, wherein generating includes: performing a heuristic analysis to compare the received information to semantic model information associated with existing semantic models of at least one other device type; and determining, based on the comparison to the semantic model information associated with existing semantic models, that an existing semantic model includes characteristics having a similarity to the first device above a similarity threshold for associating the first device with the new semantic model; storing, by the SRS, the new semantic model in a semantic model repository; and associating, by the SRS, the first device with the new semantic model.

In a fifth aspect, combinable with any of the previous aspects, wherein generating the new semantic model comprises: providing, by the SRS for presentation to a user, a suggestion including semantic model information for the first device; receiving, by the SRS, user-provided changes to the suggestion; and updating, by the SRS using the suggestion and the user-provided changes, the new semantic model.

In a sixth aspect, combinable with any of the previous aspects, further comprising: generating, by the SRS, a confidence level for the suggestion based on the a heuristic analysis; and providing the confidence level with the suggestion.

In a seventh aspect, combinable with any of the previous aspects, further comprising: receiving, by the SRS, the device ID of the first device, a new payload containing information of a payload information type not previously provided by the first device, and semantic information associated with the first device; determining, by the SRS, the semantic model associated with the first device; and updating, by the SRS, the semantic model associated with the first device using the payload information type.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example environment for processing semantic information for an Internet of Things (IoT) device.

FIG. 2 is a block diagram showing an example of information flow for Internet of everything information.

FIG. 3 is a flowchart of an example method for using digital twins and models for processing information received from devices.

FIG. 4 is a block diagram of an exemplary computer system used to provide computational functionalities associated with described algorithms, methods, functions, processes, flows, and procedures as described in the instant disclosure.

### DETAILED DESCRIPTION

This disclosure generally describes computer-implemented methods, software, and systems for processing information received from Internet of Things (IoT) devices. The connected world of IoT devices allows information associated with the IoT devices to be sent and received. The information can also include various types of semantics that are bound to the corresponding data. The semantics can enable systems not only to be semantical by definition but also to be semantical by themselves. Some systems do not “know” what the semantics of the processed data are. The systems only “know” by definition because a human defines what the processing system does. If a sender sends not only its data but also the semantics, the receiving system is able to recognize what the semantics are and is able to process data in a semantic way. This concept covers the idea of how communication among senders and receivers in general can be done in a semantic way.

Information that is received from an IoT device can include the data plus semantics. A human may be able to understand and process information, but not the data unless semantics are present. For example, a message such as “Here is the number 06227 747474” is initially communicated as data only. However, a human can interpret the number as a telephone number because the number appears to be (or is in the format of) a telephone number. The interpretation can be done by the human who may recognize the “number” keyword and then compares the number itself with patterns that the user has seen before.

However, if the message is “Here is the telephone number of Company A: 06227 747474,” then the semantics of the sentence are completely clear. The same is true if the message is rearranged, such as in “06227 747474 is the telephone number of Company A,” in which case the semantic meaning is exactly the same. If a human wants to call this number, it is not even relevant if the number is “06227 747474” or “1234567890”. This is because what matters for the human is the semantics of the data and not the data itself, at least in the context of a telephone call. In this context, the data itself is only relevant for the receiver of the data, in this case the phone. But the semantics are not relevant to the phone. This example shows that processing data and their semantics are different depending on the context in which they are processed.

### Processors and Receivers

Consider that the human can be defined as “the processor” and the phone can be defined as “the receiver”. The human “processor” must understand the semantics of the information in order to decide what to do with the data. For example, the communication “Please call 911!” would instantly be interpreted by a human residing in the United States to be in the context of an emergency, since “911” is the emergency number in the United States. If “911” were replaced by “123”, the human would likely still recognize the communication to be in the context of an emergency, but only through pattern recognition, since “123” is not a recognizable emergency-related number. At the very least, if the human failed to interpret the information as emergency-related, he or she would still understand that they were being asked to call the specified number.

However, if the human does not understand the context because he or she is unaware that the number is an emergency number, the human may not react quickly to the situation. One could easily change the sentence to “I have an emergency. Please call 911.” The provided information clearly indicates the context and the required action: call this number right away and request help. In this example, the data itself (the telephone number) is not relevant to the processor since the processor only decides what the context is, what to do with the data, and how to “route” the data to the receiver (the phone). The phone acting as the receiver does not know the context or the semantics of the data. The phone only receives and executes the action of calling the number.

In some instances, where the symbol “#” is placed in front of the number, then the role of the receiver can be changed to the role of the processor, and the new “receiver” can be the internal processing engine of the phone. This is because the phone now interprets the incoming “data” not merely data, but also as information. In a human-readable sentence, the data can be interpreted as “Hey Phone, please execute the command 123456789.” “123456789” could be the code for a restart command. However, the restart feature could be executed with “#098765432” instead. Using the same principles as described in the example of the emergency number, the semantics and context are needed to process (including organizing, distributing, and persisting) the data. To analyze and execute the action (in a defined context that is derived from the semantics), the data is also needed.

### Processing Information in Internet of Everything Scenarios

Assume that a sending device sends information, and not only the data. This means that the payload sent by the device includes semantics with the data. The processor can then determine how to handle (for example, organize, distribute, and persist) the information without knowing anything about the data part itself.

One example real-world scenario is one in which an intelligent device (for example, a sensor) sends the following JSON payload to a processor:

{

“semantics”: {

“type”: “Temperature”,
“units”: “Degrees”
},
“data”: 25

}

The processor receives the JSON payload, and because the payload includes a temperature value, the processor can analyze the semantics. The information in the payload can be persisted in storage without knowing anything about the data itself.

Subsequent to the persistence of the information, a user (for example, a consumer) can connect to the processor. The user can subscribe, for example, to all temperature information. The subscription can indicate, for example, that if any temperature information is available to the processor, then the processor should route the temperature information to the user. Then, over time, as temperature information becomes available, the processor can continuously gather the temperature information and route the temperature information to the user. The user only requests the information because the user knows what the data is, because the user has subscribed to temperature information.

This type of information subscription and delivery means that an intelligent semantic repository is needed. For example, the intelligent semantic repository can be capable of understanding the information. The intelligent semantic repository can also be capable of using the information to create abstractions and derivations for models, including handling the semantic data. The intelligent semantic repository can also be capable of providing corresponding semantic interfaces to distribute information to subscribing users. The users, on the other side, can subscribe to information instead of just receiving data from abstract interfaces. This arrangement between the intelligent semantic repository and the users can enable all parties to communicate in a semantic way. An example communication can be along the lines of: “I have a device that sends information A, and I have a consumer (e.g., using a user interface) who can consume information A.”

### The Intelligent Semantic Repository

An intelligent semantic repository as described herein is a component that is able to receive any information (including semantics plus data), identify and interpret the semantics, and offer a mechanism to process the data semantically based on the additional semantic knowledge. In one example, that the sending device may not only send information but also an additional identifier that uniquely identifies the sender. For example, a unique ID can be “1234-ewr-fgb-ert-adf-456”. An example of a payload that includes the unique ID is:

{

“semantics”: {

“deviceId”: “1234-ewr-fgb-ert-adf-456”,
“type”: “Temperature”,
“units”: “Degrees”
},
“data”: 25

}

The intelligent semantic repository can identify the device and create a digital representation called a digital twin as a single instance. The digital twin can serve as the digital representation of the real-world device and can be logically bound to the real-world device. The digital twin can include all of the information associated with the real-world device, including a digital representation of all possible features and operations of the real-world device. The real-world device can both send and receive information.

The use of digital twins introduces a need for a more appropriate way to express the semantics, features, and operations of the real-world device projected on a digital twin inside an intelligent semantic repository. In some implementations, an OData specification (https://www.odata.org/) can be used. The OData specification can be used to define a complete model which represents the semantics and features of the device/digital twin. The sender can now send a model identifier which enables the intelligent semantic repository to “understand” not only the type of the data but also “know” where the device is located. For example, a temperature sensor can exist inside a refrigerator owned by Company O, located in City C, produced by Company P. Further, the refrigerator itself can have a digital twin representing the refrigerator itself while containing other digital twins representing its sensors. Generally, all system landscapes can handle digital twins as the digital twins are instances representing the real-world devices. An example can be associated with the following information sent by the sender/device:

{

“semantics”: {

“deviceId”: “1234-ewr-fgb-ert-adf-456”,
“modelId”: “<namespace.company.device.model.xyz> |

unique model id”,

},
“data”: {...}

}

The intelligent semantic repository is able to recognize the model automatically. This can be done by using a heuristic algorithm that tries to determine what kind of data is used and defines a temporary model which can be specified later on through human intervention. This can enable the intelligent semantic repository to accept data.

### Handling Digital Twins

The intelligent semantic repository can link the digital twins to accounts associated, for example, with users, companies, and organizations. The accounts can represent the owners or managers of the devices and their digital twins. Using the linking of the accounts, the intelligent semantic repository is able to organize transfers and distribute digital twins from account to account, for example, as durable (for selling) or temporary (for rentals). This can enable each customer and consumer of the intelligent semantic repository to integrate all devices directly without doing anything further. The owners of the devices (and corresponding digital twins) can transfer the digital twins from the owners to customer accounts, enabling the customer to use the digital twin, or an instance thereof, directly. In some implementations, blockchain technology can be used to manage each digital twin instance. This can ensure the integrity and validity of each instance of a digital twin.

In a real world example, a car rental company may own a digital twin representing each of a car and a corresponding key. A customer may want to rent the car but only with an intention to use the car at night and on weekends. To meet the customer's needs in a rental contract, for example, on a given Friday, the rental company can transfer the digital twin (including the key) to the customer's account for limited use from Friday at 5 PM to Monday at 8 AM. The customer can then use the car, which is set up to recognize the key (for example, serving as the digital twin), through the user's smartphone during the contracted time.

Implementations of the present disclosure can produce the following advantages. Device and sensor producers can offer their customers with a complete integration scenario by just plugging in the sensor or device at the customer's location. End users, such as consumers, can handle and manage their devices inside of their Internet of Everything (IoE) accounts. Producers can offer complete solutions to their customers by providing IoE devices and platforms. Onboarding, maintenance, billing, distribution, analytics, and predictive maintenance of devices can be performed through digital twins. By providing a semantic layer, including a semantic model repository, all parties can handle information and not only data. This can enable systems to understand what kind of data is consumed and how the data can and should be processed.

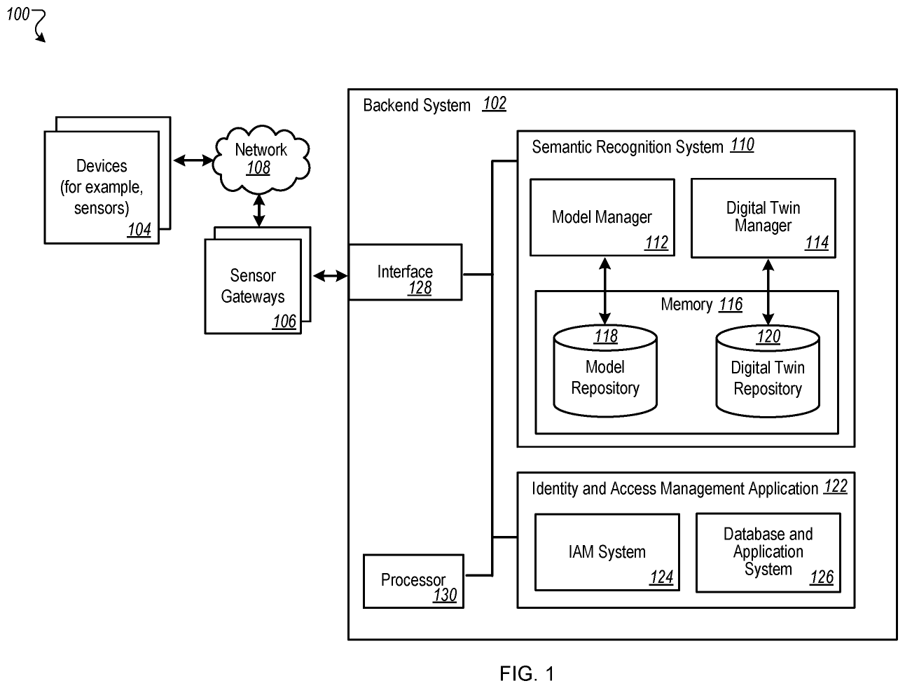

FIG. 1 is a block diagram of an example environment 100 for processing semantic information for an IoT device. The environment 100 includes a backend system 102 that receives data from devices 104, such as sensors. The data can include, for example, temperature readings of the sensors. Other types of devices 104 can send other types of information, such as location information for devices 104 that are mobile, or transactional information for devices 104 that handle transactions, such as sales to users (for example, kiosks).

Information that the backend system 102 receives from the devices 104 can first pass through sensor gateways 106. The sensor gateways 106 can add semantic information to the data provided by the devices 104 before the data is received by the backend system 102. In some implementations, such as for legacy devices/sensors, an Internet protocol (IP) address or port can be used as an ID within a known context. In some implementations, sensors can generate or provide a global unique ID that is associated with the sensor.

Data and semantic information that is sent and received within the environment 100 can go through a network 108. For example, the network 108 can include the Internet through which IoT devices, including the devices 104, send and receive information.

In some implementations, the sensor gateways 106 can be part of the devices 104, such as if a particular device 104 is itself able to add semantic information to the data that is sent for processing by the backend system 102. In some implementations, a single sensor gateway 106 can serve one or more types of devices 104, such as a sensor gateway 106 that serves more than one sensor at a particular location or a group of locations. Multiple levels or hierarchies of sensor gateways 106 can exist, meaning that data can pass through multiple gateways, with each gateway potentially adding semantic information.

The backend system 102 includes a semantic recognition system 110 that performs semantics-related functions of the backend system 102. A model manager 112 manages and provides access to semantic models. A digital twin manager 114 provides access to, and is capable of creating, digital twins. Memory 116 stores information used by the semantic recognition system 110, including a model repository 118 and a digital twin repository 120. The digital twin repository 120 stores the digital twin associated with the devices 104. The digital twin repository 120 also supports interactions to be performed with sensors by affecting the corresponding digital twin.

An identity and access management application 122 includes an identity and access management (IAM) system 124 and a database and application system 126. The identity and access management application 122 stores links to the digital twins, allowing interactions to be performed with the devices 104 by affecting the digital twin.

An interface 128 of the backend system 102 can handle information (including data and semantics) that is received from the sensor gateways 106. At least one processor 130 can perform the processing functions of the backend system 102. For example, the at least one processor 130 can execute instructions of the interface 128, the semantic recognition system 110, and the identity and access management application 122, including their components. The interface 128 can serve as a generic interface that accepts different kinds of data and uses different kinds of protocols. The interface 128 can serve as a router, for example, by routing received data to a recognizer which determines the correct corresponding patterns, semantics, and models.

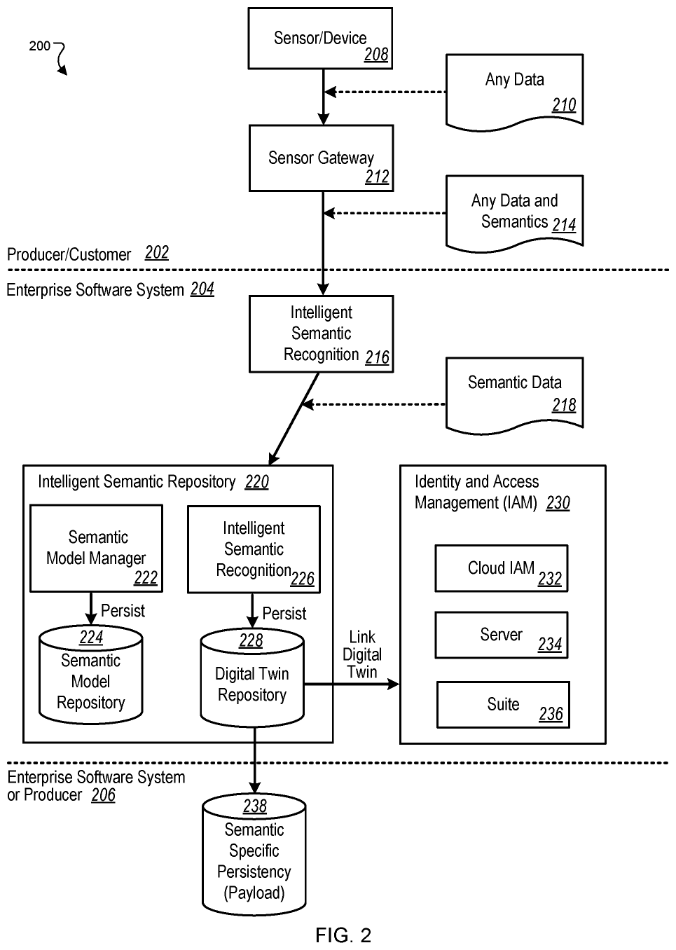

FIG. 2 is a block diagram showing an example of information flow 200 for Internet of Everything information and the use of digital twins as described in one implementation. The information flow 200 includes operations that span a producer/customer 202, an enterprise software system 204, and an enterprise software system or producer 206.

The information flow 200 can begin when a sensor/device 208 sends any data 210 that is received by a sensor gateway 212. The sensor gateway 212 can add semantics, so that data and semantics 214 are received by an intelligent semantic recognition system 216. The intelligent semantic recognition system 216 adds semantic data 218 to the information before the information is received at an intelligent semantic repository 220.

The intelligent semantic repository 220 includes a semantic model manager 222 that can persist information to a semantic model repository 224. The intelligent semantic repository 220 also includes an intelligent semantic recognition 226 that can persist information to a digital twin repository 228.

The digital twin repository 228 can store the electronic representation for a given device (for example, a sensor) allowing interactions to be performed on the given device. The interactions can include, for example, retrieving or receiving information associated with the given device, such as a temperature reading that is received or some information that requested, such as a current status or statistical information.

The intelligent semantic repository 220 can create a digital twin for the sensor/device 208 and create a link to the digital twin that is provided to an identity and access management (IAM) 230. The IAM 230 includes a cloud IAM 232, a server 234, and a suite 236. The IAM 230 can maintain a link to the digital twin of each device. The digital twin repository 228 can store payload information for the received sensor/device information in a semantic specific persistency (payload) 238. The semantic specific persistency (payload) 238 can store the data/payloads sent by the sensors/devices. A function of the repository is to store information in a way that the payload itself is linked to its semantic. The goal is to be able to reproduce the data out of the persistency without needing to provide “hard conditions” such as “WHERE key=123” but more like “WHERE temperature data is for device XYZ.” The persistency must understand abstractions such as getting temperature data for all devices. Therefore, the persistency must understand what temperature data is. To achieve this, each data item includes a binding to its corresponding model describing the semantics.

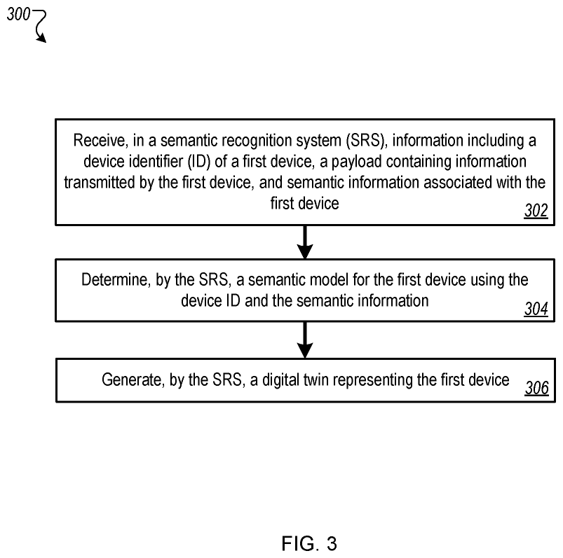

FIG. 3 is a flowchart of an example method 300 for using digital twins and models for processing information received from devices. Method 300 can be performed by the system 100, for example. For clarity of presentation, the description that follows generally describes method 300 in the context of FIGS. 1 and 2.

At 302, information is received in a semantic recognition system (SRS) that includes a device identifier (ID) of a first device, a payload containing information transmitted by the first device, and semantic information associated with the first device. The first device can be a sensor, for example. The backend system 102, for example, can receive a payload and device ID of the device 104 that is routed through the sensor gateway 106.

In some implementations, the information that is received can be provided by a sensor gateway that adds the semantic information. For example, the sensor gateway 212 can add semantics to the data 210 received from the sensor/device 208 before sending the information to the intelligent semantic recognition system 216. From 302, method 300 proceeds to 304.

At 304, a semantic model for the first device is determined by the SRS using the device ID and the semantic information. For example, the semantic recognition system 110 can use the device ID of device 104 to determine the model associated with the device.

In some implementations, determining the semantic model includes identifying and using the device identifier (ID) of the first device and the semantic information associated with the first device, an existing semantic model associated with the first device. For example, the semantic recognition system 110 can identify an existing model for the device 104 if the model already exists in the model repository 118.

In some implementations, determining the semantic model can include steps for creating a model from an existing model. For example, a heuristic analysis can be performed to compare the received information to semantic model information associated with existing semantic models of at least one other device type. Based on the comparison to the semantic model information associated with existing semantic models, a determination can be made that an existing semantic model includes characteristics having a similarity to the first device above a similarity threshold for associating the first device with the new semantic model. The SRS can store the new semantic model in a semantic model repository. The SRS can associate the first device with the new semantic model.

In some implementations, heuristic analyses can be done by testing against well-known formats such as comma-separated values (CSV), JavaScript Object Notation (JSON), extensible markup language (XML), and yet another markup language (YAML). In some implementations, an abstract syntax tree (AST) can be created. Input to the AST can include, For example, “a,{b: ‘c,2,<any>hello<any>’, d: 1},<node>{e: ‘f’}<node/>” which can result in a pseudo abstract syntax tree such as:

csv
- string
- json

- b: csv

- string
- number
- xml

- any

- type: string
- value: hello

- d: number

- xml

- node

- type: json
- value

e: string

After creating the abstract syntax tree, an abstract model can be created that describes the data structure. The abstract model can be used to find matching (sub-) patterns in comparison with other existing models. In some implementations, machine learning can be used to identify recurring patterns.

In an example, a car engine may send arbitrary data such as rotations per minute (RPM), temperature, and oil consistency. Determining sub-semantics for the data can include comparing existing semantics with current recognized patterns. For example, if a model exists that includes elements such as RPM, temperature, and oil consistency, then the data that is sent by the car can be determined to belong to (or be associated with) an engine. In this way, the semantic repository “knows” what an engine is. The semantic repository can create a corresponding model for comparison with received data structures.

The semantic repository can be used in interpreting an underlying structure, comparing the data structure to well-known models. If a model is identified, then the system “knows” what the data structure is. If a model is not identified, then a new model can be created. The new model can be interpreted as “model x” until the system is informed (for example, by a human) that the model can be identified (or labeled) as an “engine model.” However, the identification may only be needed for human readability.

In some implementations, determining the semantic model can include steps for suggesting a model to a user and receiving input from the user regarding the suggestion. For example, generating the new semantic model can include providing, by the SRS for presentation to a user, a suggestion. The suggestion can include semantic model information for the first device. The SRS can receive user-provided changes to the suggestion. The SRS can update the new semantic model based on the suggestion and the user-provided changes.

In some implementations, the method 300 can further include assigning a confidence lever to the suggestion before providing the suggestion for presentation to the user. For example, the SRS can generate a confidence level (for example, a confidence score) for the suggestion based on a heuristic analysis. The SRS can then provide the confidence level with the suggestion. From 304, method 300 proceeds to 306.

At 306, a digital twin representing the first device is generated by the SRS. For example, the digital twin manager 114 can create a digital twin for the device for storage in the digital twin repository 120. After 306, method 300 stops.

In some implementations, method 300 can further include steps to update an existing model. For example, the SRS can receive information that includes the device ID of the first device, a new payload containing information of a payload information type not previously provided by the first device, and semantic information associated with the first device. The SRS can determine the semantic model associated with the first device. The SRS can then update the semantic model associated with the first device using the payload information type.

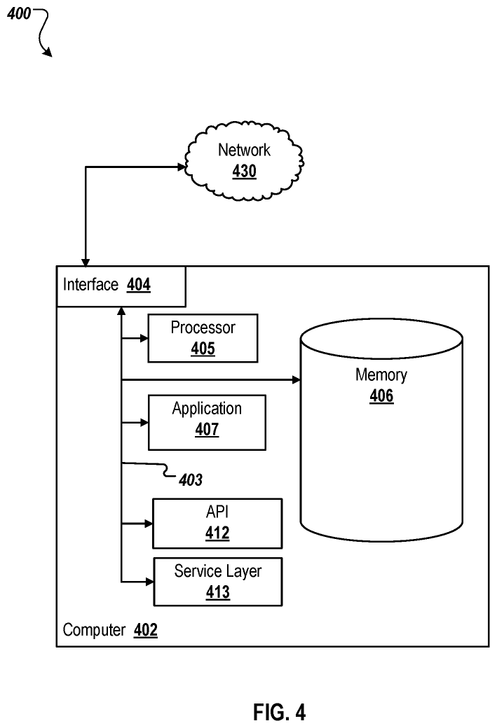

FIG. 4 is a block diagram of an exemplary computer system 400 used to provide computational functionalities associated with described algorithms, methods, functions, processes, flows, and procedures as described in the instant disclosure.

The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual information, audio information, a combination of different information types, or a graphical user interface (GUI).

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over a network 430 from a client application (for example, executing on another computer 402), and respond to the received requests by processing those requests in an appropriate software application. In addition, requests may also be sent to the computer 402 from internal users (for example, from a command console or by any other appropriate access method), external users, third-parties, other automated applications, or any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application program interface (API) 412 or a service layer 413 (or a combination of an API 412 and a service layer 413). The API 412 may include specifications for routines, data structures, and object classes. The API 412 may be either computer-language independent or dependent and refer to a complete interface, a single function, or a set of APIs. The service layer 413 provides software services to the computer 402 or other components (whether illustrated or not) that are communicably coupled to the computer 402. The functionality of the computer 402 may be accessible for all service consumers using this service layer. Software services, such as those provided by the service layer 413, provide reusable, defined business functionalities through a defined interface. For example, the interface may consist of software written in JAVA, C++, or other suitable language, providing data in extensible markup language (XML) format or another suitable format. While illustrated as an integrated component of the computer 402, alternative implementations may illustrate the API 412 or the service layer 413 as stand-alone components in relation to other components of the computer 402 or other components (whether illustrated or not) that are communicably coupled to the computer 402. Moreover, any or all parts of the API 412 or the service layer 413 may be implemented as children or sub-modules of another software module, enterprise application, or hardware module without departing from the scope of the instant disclosure.

The computer 402 includes an interface 404. Although illustrated as a single interface 404 in FIG. 4, two or more interfaces 404 may be used according to particular needs, desires, or implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals inside or outside of the illustrated computer 402.

The computer 402 includes a processor 405. Although illustrated as a single processor 405 in FIG. 4, two or more processors may be used according to particular needs, desires, or implementations of the computer 402. Generally, the processor 405 executes instructions and manipulates data to perform the operations of the computer 402 using algorithms, methods, functions, processes, flows, and procedures such as those described in the instant disclosure.

The computer 402 also includes a memory 406 that holds data for the computer 402 or other components (or a combination of both) that can be connected to the network 430 (whether illustrated or not). For example, memory 406 can be a database storing data consistent with this disclosure. Although illustrated as a single memory 406 in FIG. 4, two or more memories may be used according to particular needs, desires, or implementations of the computer 402 and the described functionality. While memory 406 is illustrated as an internal component of the computer 402, in alternative implementations, memory 406 can be external to the computer 402.

The application 407 is an algorithmic software engine providing functionality according to particular needs, desires, or implementations of the computer 402, particularly with respect to the functionality described in this disclosure. For example, application 407 can serve as one or more components, modules, applications, etc. Further, although illustrated as a single application 407, the application 407 may be implemented as multiple applications 407 on the computer 402. In addition, although illustrated as internal to the computer 402, in alternative implementations, the application 407 can be external to the computer 402.

There may be any number of computers 402 associated with a computer system containing computer 402, each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

In some implementations, components of the environments and systems described above may be any computer or processing device such as, for example, a blade server, a general-purpose personal computer (PC), a Macintosh workstation, a UNIX-based workstation, or any other suitable device. In other words, the present disclosure contemplates computers other than general purpose computers, as well as computers without conventional operating systems. Further, components may be adapted to execute any operating system, including Linux, UNIX, Windows, Mac OS®, Java™, Android™, iOS or any other suitable operating system. According to some implementations, components may also include, or be communicably coupled with, an e-mail server, a web server, a caching server, a streaming data server, and/or other suitable server(s).

Processors used in the environments and systems described herein may be a central processing unit (CPU), an application specific integrated circuit (ASIC), a field-programmable gate array (FPGA), or another suitable component. Generally, each processor can execute instructions and manipulate data to perform the operations of various components. Specifically, each processor can execute the functionality required to send requests and/or data to components of the environment and to receive data from the components of the environment, such as in communication between the external, intermediary, and target devices.

Components, environments, and systems described above may include a memory or multiple memories. Memory may include any type of memory or database module and may take the form of volatile and/or non-volatile memory including, without limitation, magnetic media, optical media, random access memory (RAM), read-only memory (ROM), removable media, or any other suitable local or remote memory component. The memory may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, for references thereto associated with the purposes of the target, intermediary, and external devices. Other components within the memory are possible.

Regardless of the particular implementation, “software” may include computer-readable instructions, firmware, wired and/or programmed hardware, or any combination thereof on a tangible medium (transitory or non-transitory, as appropriate), operable when executed to perform at least the processes and operations described herein. Each software component may be fully or partially written or described in any appropriate computer language including C, C++, Java™, Visual Basic, assembler, Perl®, any suitable version of 4GL, or any other suitable computer language. Software may include a number of sub-modules, third-party services, components, libraries, etc., as appropriate. Conversely, the features and functionality of various components can be combined into single components as appropriate.

Devices can encompass any computing device such as a smart phone, tablet computing device, PDA, desktop computer, laptop/notebook computer, wireless data port, one or more processors within these devices, or any other suitable processing device. For example, a device may comprise a computer that includes an input device, such as a keypad, touch screen, or other device that can accept user information, and an output device that conveys information associated with components of the environments and systems described above, including digital data, visual information, or a GUI. The GUI interfaces with at least a portion of the environments and systems described above for any suitable purpose, including generating a visual representation of a web browser.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

1. A computer-implemented method comprising:
receiving, in a semantic recognition system (SRS), information including a device identifier (ID) of a first device, a payload containing information transmitted by the first device, and semantic information associated with the first device;
determining, by the SRS, a semantic model for the first device using the device ID and the semantic information; and
generating, by the SRS, a digital twin representing the first device.

2. The computer-implemented method of claim 1, wherein the first device is a sensor.

3. The computer-implemented method of claim 1, wherein the received information is received from a sensor gateway that adds the semantic information.

4. The computer-implemented method of claim 3, wherein determining the semantic model includes identifying, using the device ID of the first device and the semantic information associated with the first device, an existing semantic model associated with the first device.

5. The computer-implemented method of claim 3, wherein determining the semantic model comprises:
generating, by the SRS, a new semantic model for a device type associated with the first device, wherein generating includes:
performing a heuristic analysis to compare the received information to semantic model information associated with existing semantic models of at least one other device type; and
determining, based on the comparison to the semantic model information associated with existing semantic models, that an existing semantic model includes characteristics having a similarity to the first device above a similarity threshold for associating the first device with the new semantic model;
storing, by the SRS, the new semantic model in a semantic model repository; and
associating, by the SRS, the first device with the new semantic model.

6. The computer-implemented method of claim 5, wherein generating the new semantic model comprises:
providing, by the SRS for presentation to a user, a suggestion including semantic model information for the first device;
receiving, by the SRS, user-provided changes to the suggestion; and
updating, by the SRS using the suggestion and the user-provided changes, the new semantic model.

7. The computer-implemented method of claim 6, further comprising:
generating, by the SRS, a confidence level for the suggestion based on the a heuristic analysis; and
providing the confidence level with the suggestion.

8. The computer-implemented method of claim 1, further comprising:
receiving, by the SRS, the device ID of the first device, a new payload containing information of a payload information type not previously provided by the first device, and semantic information associated with the first device;
determining, by the SRS, the semantic model associated with the first device; and
updating, by the SRS, the semantic model associated with the first device using the payload information type.

9. A system comprising:
memory storing tables storing model repository information and digital twin repository information; and
a server performing operations comprising:
receiving, in a semantic recognition system (SRS), information including a device identifier (ID) of a first device, a payload containing information transmitted by the first device, and semantic information associated with the first device;
determining, by the SRS, a semantic model for the first device using the device ID and the semantic information; and
generating, by the SRS, a digital twin representing the first device.

10. The system of claim 9, wherein the first device is a sensor.

11. The system of claim 9, wherein the received information is received from a sensor gateway that adds the semantic information.

12. The system of claim 11, wherein determining the semantic model includes identifying, using the device ID of the first device and the semantic information associated with the first device, an existing semantic model associated with the first device.

13. The system of claim 11, wherein determining the semantic model comprises:
generating, by the SRS, a new semantic model for a device type associated with the first device, wherein generating includes:
performing a heuristic analysis to compare the received information to semantic model information associated with existing semantic models of at least one other device type; and
determining, based on the comparison to the semantic model information associated with existing semantic models, that an existing semantic model includes characteristics having a similarity to the first device above a similarity threshold for associating the first device with the new semantic model;
storing, by the SRS, the new semantic model in a semantic model repository; and
associating, by the SRS, the first device with the new semantic model.

14. The system of claim 13, wherein generating the new semantic model comprises:
providing, by the SRS for presentation to a user, a suggestion including semantic model information for the first device;
receiving, by the SRS, user-provided changes to the suggestion; and
updating, by the SRS using the suggestion and the user-provided changes, the new semantic model.

15. The system of claim 14, the operations further comprising:
generating, by the SRS, a confidence level for the suggestion based on the a heuristic analysis; and
providing the confidence level with the suggestion.

16. The system of claim 9, the operations further comprising:
receiving, by the SRS, the device ID of the first device, a new payload containing information of a payload information type not previously provided by the first device, and semantic information associated with the first device;
determining, by the SRS, the semantic model associated with the first device; and
updating, by the SRS, the semantic model associated with the first device using the payload information type.

17. Non-transitory computer-readable media encoded with a computer program, the program comprising instructions that when executed by one or more computers cause the one or more computers to perform operations comprising:
receiving, in a semantic recognition system (SRS), information including a device identifier (ID) of a first device, a payload containing information transmitted by the first device, and semantic information associated with the first device;
determining, by the SRS, a semantic model for the first device using the device ID and the semantic information; and
generating, by the SRS, a digital twin representing the first device.

18. The non-transitory computer-readable media of claim 17, wherein the first device is a sensor.

19. The non-transitory computer-readable media of claim 17, wherein the received information is received from a sensor gateway that adds the semantic information.

20. The non-transitory computer-readable media of claim 19, wherein determining the semantic model includes identifying, using the device ID of the first device and the semantic information associated with the first device, an existing semantic model associated with the first device.
